(19) United States
(12) Patent Application Publication
(10) Pub. No.: US 2002/0111853 A1
(43) Pub. Date: Aug. 15, 2002

(54) Specification linking to meet the needs of a buyer

(76) Inventor: John F. O'Ryan, Virginia Beach, VA (US)

Correspondence Address: Jeffrey K. Seto, 617 Tinkerbell Rd., Chapel Hill, NC, 27514, US

(21) Appl. No.: 09/764,937

(22) Filed: Jan. 18, 2001

(51) Int. Cl. G06F 17/60

(52) U.S. Cl. 705/14

(57) ABSTRACT

An electronic commerce system that provides information to buyers so that a restricted buyer, such as a government purchasing agent, can justify their purchases and an unrestricted buyer, such as a concerned consumer, can find government approved and award winning products and services. The present electronic commerce system also provides buyers with specific information that the buyers need before they can make a required purchase, such as architectural specifications. Buyers select from broad categories and are lead through a logical database of informational webpages to the specific product or service for which they are looking. The good or service is presented as text, a picture, or a multi-media presentation, along with a list of rules, orders, statutes and other “regulations” that the good or service meets, qualifies or otherwise falls within. The list can also include honors, accolades, and “awards” won by the product or service. Each “regulation” and “award” is actually a hyper link to the text of the regulation which the buyer can print out locally and use either as justification, to make a more informed purchasing decision, or to find the specifications of required purchase.

### BACKGROUND OF THE INVENTION

The present invention relates generally to field of procurement and more specifically to the field of electronic procurement for buyers.

Government purchasing agents, by the very nature of their job, conduct their work under many complicated regulations. When a government purchasing agent purchases goods or services, they are spending tax dollars and thus their purchases must be efficient and justified. Many times providing the required justification for purchases is extremely time consuming and in the worst cases causes the purchasing agent to abandon a deal involving a superior product. The agent would then end up purchasing an inferior product that met less of the end customer's needs but, was easier to purchase.

Local, State and the Federal Governments provide a significant amount of business to United States (US) manufacturers and sales organizations. The transactions are usually large in scale, and in many cases solicited and closed by independent sales representatives. With the emergence of e-commerce, a new dimension has been added to traditional business methods. Technology is forcing the transformation of standard sales practices. The most noticeable change has been the acceleration of the procurement cycle. Advancements in communication and information exchange systems have made quality improvements to the normal business process, which have decreased total transaction time and increased the visibility of vendors and products to buyers. But, not all products can be purchased by a restricted buyer, such as a government purchasing agent.

The federal government is quite possibly the most complex of all institutional markets. Even though the federal procurement laws are clearly defined, their vast size and compartmentalization makes marketing and contracting difficult for even the most experienced sales organizations. The Federal Acquisition Regulations (FAR) provide US purchasing agents with rules they must follow during the performance of their jobs.

The General Services Administration (GSA) directs and manages Federal buyers and provides Federal agencies, via the Federal Supply Schedule system, with a simplified process for obtaining commonly used commercial supplies and services at prices associated with volume buying. Indefinite delivery contracts (including requirements contracts) are established with commercial firms to provide supplies and services at stated prices for given periods of time. Similar systems of schedule-type contracting are used for military items managed by the Department of Defense.

The GSA schedule contracting office issues publications, entitled Federal Supply Schedules, containing the information necessary for placing delivery orders with schedule contractors. Ordering offices can issue delivery orders directly to the schedule contractors for the required supplies and services.

GSA also offers an on-line shopping service called “GSA Advantage!” that enables ordering offices to search product specific information (i.e., national stock number, part number, common name), review delivery options, place orders directly with contractors (or ask GSA to place orders on the agency's behalf, and pay contractors for orders using the Governmentwide commercial purchase card (or pay GSA). Ordering offices may access the “GSA Advantage!” shopping service by connecting to the Internet and using a web browser to connect to the Acquisition Reform Network (http://www.arnet.gov) or the GSA, Federal Supply Service (FSS) Home Page (http://www.fss.gsa.gov).

In order to take advantage of purchasing via the FSS, buyers must obey the procedures outlined in the FAR, some of which are reproduced below.

(1) Orders at or below the micro-purchase threshold are placed with any Federal Supply Schedule contractor.

(2) Orders exceeding the micro-purchase threshold but not exceeding the maximum order threshold are placed with the schedule contractor that can provide the supply or service that represents the “best value”. Before placing an order, consider reasonably available information about the supply or service offered under Multiple Award Schedule (MAS) contracts by using the GSA Advantage! on-line shopping service, or by reviewing the catalogs or pricelists of at least three schedule contractors. When selecting the supply or service representing the best value, the ordering office may consider:

(i) Special features of the supply or service required for effective program performance;

(ii) Trade-in considerations;

(iii) Probable life of the item selected as compared with that of a comparable item;

(iv) Warranty considerations;

(v) Maintenance availability;

(vi) Past performance; and

(vii) Environmental and energy efficiency considerations.

(3) Orders exceeding the maximum order threshold. Each schedule contract has an established maximum order threshold. This threshold represents the point where it is advantageous for the ordering office to seek a price reduction. In addition to following the procedures in paragraph (b)(2) of this section and before placing an order that exceeds the maximum order threshold:

(i) Review additional schedule contractors' catalogs or pricelists, or use the GSA Advantage! on-line shopping service;

(ii) Based upon the initial evaluation, generally seek price reductions from the schedule contractor(s) appearing to provide the best value (considering price and other factors); and

(iii) After seeking price reductions, place the order with the schedule contractor that provides the best value and results in the lowest overall cost alternative (see 8.404(a)).

(4) Blanket purchase agreements (BPAs). Agencies may establish BPAs (see 13.303-2(c)(3)) when following the ordering procedures in this subpart. All schedule contracts contain BPA provisions. Ordering offices may use BPAs to establish accounts with contractors to fill recurring requirements. BPAs should address ordering frequency, invoicing, discounts, and delivery locations and times.

(5) Price reductions. In addition to the circumstances in paragraph (b)(3) of this section, there may be other reasons to request a price reduction. For example, seek a price reduction when the supply or service is available elsewhere at a lower price or when establishing a BPA to fill recurring requirements. The potential volume of orders under BPAs, regardless of the size of the individual order, offer the opportunity to secure greater discounts. Schedule contractors are not required to pass on to all schedule users a price reduction extended only to an individual agency for a specific order.

(6) Small business. When conducting evaluations and before placing an order, consider including, if available, one or more small, women-owned small, and/or small disadvantaged business schedule contractor(s). Orders placed against the schedules may be credited toward the ordering agency's small business goals. For orders exceeding the micro-purchase threshold, ordering offices should give preference to the items of small business concerns when two or more items at the same delivered price will satisfy the requirement.

(7) Documentation. Orders should be documented, at a minimum, by identifying the contractor the item was purchased from, the item purchased, and the amount paid. If an agency requirement in excess of the micro-purchase threshold is defined so as to require a particular brand name, product, or a feature of a product peculiar to one manufacturer, thereby precluding consideration of a product manufactured by another company, the ordering office shall include an explanation in the file as to why the particular brand name, product, or feature is essential to satisfy the agency's needs.

Ordering Procedures for Mandatory Use Schedules.

(1) In the case of mandatory schedules, ordering offices shall not solicit bids, proposals, quotations, or otherwise test the market solely for the purpose of seeking alternative sources to Federal Supply Schedules.

(2) Schedules identify executive agencies required to use them as mandatory sources of supply. The single-award schedule shall be used as a primary source and the multiple-award schedule as a secondary source. Mandatory use of schedules is not a requirement if:

(i) The schedule contractor is unable to satisfy the ordering office's urgent delivery requirement;

(ii) The order is below the minimum order thresholds;

(iii) The order is above the maximum order limitation;

(iv) The consignee is located outside the area of geographical coverage stated in the schedule; and

(v) A lower price for an identical item (i.e., same make and model) is available from another source.

Requests for Waivers.

(a) When an ordering office that is a mandatory user under a schedule determines that items available from the schedule will not meet its specific needs, but similar items from another source will, it shall submit a request for waiver to the: Commissioner, Federal Supply Service (F), GSA, Washington, DC 20406. Requests shall contain the following information:

(1) A complete description of the required items, whenever possible; e.g., descriptive literature such as cuts, illustrations, drawings, and brochures that explain the characteristics and/or construction.

(2) A comparison of prices and the technical differences between the requested item and the schedule item, identifying as a minimum the:

(i) Inadequacies of the schedule item to perform required functions; and

(ii) Technical, economic, or other advantages of the item requested.

(3) Quantity required.

(4) Estimated annual usage or a statement that the requirement is nonrecurrent or unpredictable.

The numerous and lengthy rules and regulations, such as those listed above, place a heavy burden on Federal buyers. Federal buyers are authorized to make “best value” determinations in the selection of products, however they must be able to justify these acquisitions with documentation. Too often they are faced with the problem of trying to justify their purchase as “best value” with very little proof as to that fact at their disposal. The current methods require contracting specialists and buyers to locate federal regulations and specification documents which validate their selections. Quite often they are required to research products with which they have no expertise or knowledge. A centralized library for this type of information does not exist, and there are no plans within the government to create such a library. Such a process is tedious and time consuming. The required research for even single purchases can cause a weary purchasing agent to abandon their purchase effort, resulting in the end user receiving a lowest bid product, which is not an acceptable way of doing business.

There is a need to improve the federal market sales methods. The present electronic commerce system streamlines the purchasing system, especially for buyers that must justify their purchases or whom work under similar limitations. The present system is designed to meet the needs of concerned consumers, government buyers, contractors and ultimately the taxpayer. It also promotes the idea of meeting standards and winning awards to manufacturers. Electronic architectural components were created for manufactures, sales representatives, buyers, and the Federal Acquisition Regulations (FAR) and these became the original building blocks used to define the requirements of the original system. Each component has its unique, yet essential, role within federal procurement and required total analysis. Connecting them in a seamless, logical and effective manner was the final step.

The present unique system, SPEC-LINKS™, is the process in which rapid procurement is facilitated, and printable compliance standards are directly linked, within the institutional marketplace and all other areas of market sales. A combined automated/manual process has been developed which identifies and matches all government regulations, manufacturers buyer's guides, and specialized documentation to individual product items. The system provides a complete index of specifications and regulations, empowering the consumer with all necessary information to make an informed purchase. Efficiency and effectiveness enhancement of all transactions in accordance with federal procurement regulations is a realization of the original system. The present system is adaptable to all institutional market places and can provide the necessary platform to create and maintain a network of independent sales representatives and vendors desiring to conduct business with any government, business or organization.

### SUMMARY OF THE INVENTION

An electronic commerce system that is executed on networked computer hardware and is designed to provide a purchasing agent with information regarding goods and services that meet regulations to which the purchasing agent must adhere. The printable information provides the purchasing agent with justification for the purchase of the goods and services. The system comprises a product information module that includes descriptive information about the products, that has been obtained from the product manufacture or distributor. The product information is stored in a searchable database, with proprietary software, that is connected to the Internet, in the preferred embodiment. The descriptive information is displayed in the form of text, pictures, video clips or multi-media presentations. The system also contains a justification module that displays justification information regarding each product and service. The justification information is primarily provided as a list of hyper links to specific regulations to which the purchasing agent must adhere. The regulations are listed in order of precedence and provide printable affirmative evidence of adherence to all purchasing limits pertaining to the purchasing agent.

The networked computer hardware of the system includes lap-top computers, desk-top computers, servers, routers, personal digital assistants, and cellular telephones. The computer hardware is preferably connected via the Internet, however LAN and WAN networks are also within the scope of the present system.

The justification information for the good or service can be used by: a government buyer to provide justification for a purchase; a concerned consumer to provide evidence of safety and quality; and, an unrestricted purchaser, such as a homeowner needing to replace a door, to provide architectural specifications that are required before the item can be purchased.

The present electronic commerce system can be used on a proprietary website or on a website that is hosted by a government, a company or an alliance of companies and/or governments. The system can optionally target goods and services that meet specific regulations or programs within an institution, such as the “best value” program of the federal government. Of course, other award winning type goods and services may be targeted and presented to the buyers. By identifying and promoting energy efficient and award winning type items, the present system encourages designers and manufactures to make safer and more efficient products. When companies meet energy efficiency type standards, they will automatically be promoted to a vast customer pool and in the case of government purchasing agents, with deep pockets.

The tedious hours of research required of some restricted buyers, such as government purchasing agents, is reduced to a number of simple clicks. The present electronic commerce allows a purchaser to “Print, Staple and Buy”; print out all required justification information, staple the printed information to a purchase order, and subsequently have everything required to buy the good or service.

### BRIEF DESCRIPTION OF THE DRAWINGS

The invention of the present application will now be described in more detail with reference to the accompanying drawings, given only by way of example, in which:

FIG. 1 is an exemplary display of an intermediate webpage of the present system;

FIG. 2 is an exemplary display of a subsequent webpage of the present system;

FIG. 3 is an exemplary display of a selected product and its associated Spec-Links;

FIG. 4 is another exemplary display of a selected product and its associated Spec-Links;

FIG. 5 is an exemplary display of a selected service and its associated Spec-Links; and

FIG. 6 is an example of linked justification information.

### DETAILED DESCRIPTION OF THE INVENTION

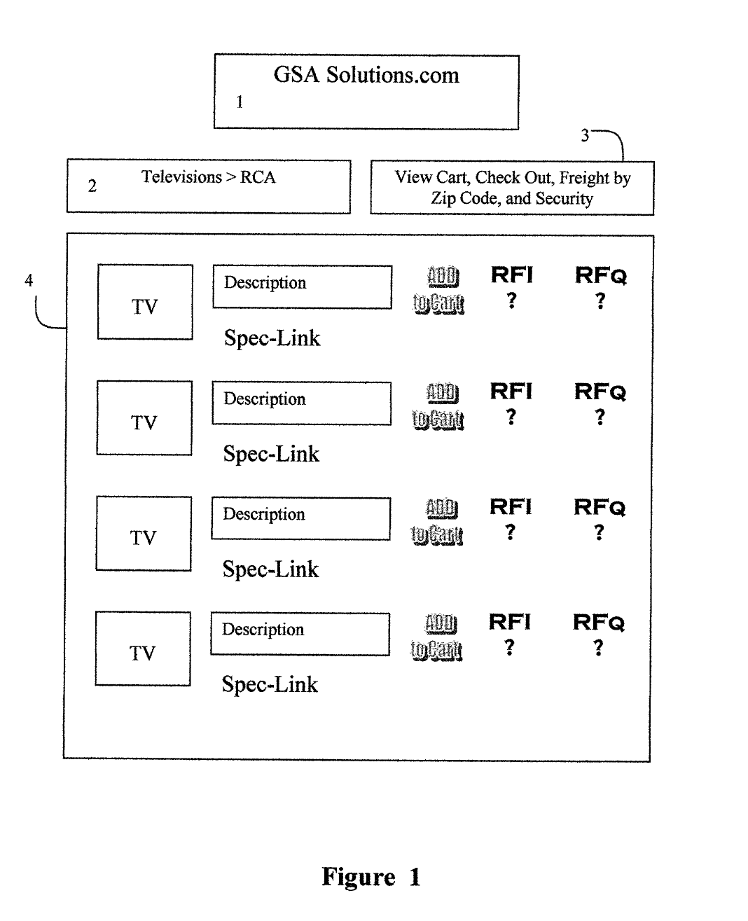

The present electronic commerce system provides an on-line catalog of products and services that is directed to a specific buyer. The buyer is guided from a broad range of products and services down to a detailed list of products or services that are specific to her needs. FIG. 1 shows an exemplary intermediate webpage that is accessible to users of the present system. In this case, the buyer is looking for television sets and after having clicked on a “Purchase” icon, a “Consumer Electronics” link, a “TV” link and a “Manufacture” link, the buyer is brought to the exemplary webpage display of FIG. 1. Of course, short cuts can be available and search capabilities are available in the present system. In this case, the manufacture is RCA and four RCA televisions are displayed with corresponding descriptions as well as several links. Window 1 is a host window and can optionally display the name of the website host or other information. Window 2 provides webpage linking information. Window 3 has three icons and a query window. A View Cart icon allows the buyer to see items already in his electronic shopping cart. A Check Out icon links to the easy electronic payment portion of the system. Finally a Security icons reassures the buyer that he is conducting his business within a secure website. The query window is for the buyer to inquire as to the shipping charges associated with his purchase. By simply entering his postal zip code, an exact shipping charge can be provided before completion of the purchase. Window 4 shows the four different RCA televisions, their corresponding descriptions, three icons per television and a hyper link entitled Spec-Link. This Spec-Links™ feature is an important part of the system. Clicking on the Spec-Link icon takes the purchaser to a complete listing of rules, regulations and statutes met by the product and awards and honors won by the product. The information provided by the Spec-Link™ feature can be used by a restricted buyer as justification for a purchase. It can also be used by a concerned consumer as evidence of safety and quality.

The ADD to Cart icon can be used by a purchaser that is familiar with the product and knows he wants to buy. By clicking this icon the buyer can add the item to his “shopping cart” at this page. The electronic shopping cart feature is well known and provides some familiarity for the buyer. Generally, the shopping cart feature allows the purchaser to add and delete items from his cart. It also facilitates checkout and electronic payment for the items. The “RFI” icon (Request For Information) links the buyer to more details about the product and allows the buyer to request a paper catalog. The RFI icon also allows the buyer to contact a vendor or a host. The “RFQ” icon (Request For Quotation) is used by purchasers that are buying more than one item and would like to see if there is a package “deal” that is available.

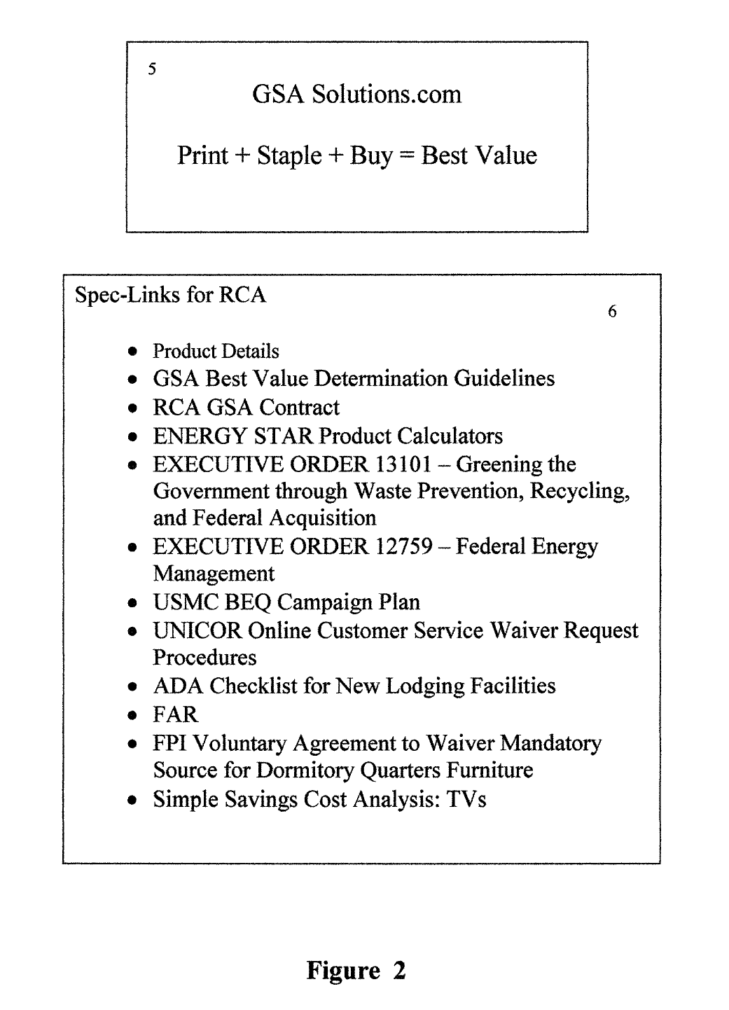

FIG. 2 is an exemplary subsequent webpage that the buyer can be transported to when he clicks on one of the Spec-Link icons of FIG. 1. Window 5 is an optional host window that in this case displays the website host, GSA Solutions.com, and the fact that the selected product has been determined to meet all of the requirements of the “Best Value” program, which is a program of the federal government. Many different criteria can be used to evaluate products and identify those in compliance with specified program. A sample list of criteria that may be used in the present system to determine compliance include: recycled content, energy efficiency, water conservation, low volatile organic compounds, lead-free items, remanufactured items, chlorine free and ozone safe items, mandatory items, military programs, seals of approval, EPA approved programs, chromate, hexavalent-chromium, mercury and benzene free items, non-toxic items, ergonomic items, and energy star compliant items. Window 6 displays a hierarchical list of all rules, regulations, Orders, and statutes (“regulations”) that the product meets as well as any awards, honors and accolades (“awards”) the product has received. Each “regulation” and “award” is presented as a hyperlink that can be clicked on with a pointing device and will take the buyer to the text of the associated “regulation” and “award”. The text of the regulation or award can be printed locally and provides affirmative evidence of justification of the purchase, which federal purchasing agents must provide in the course of their business. The present system is being shown as applied to the federal government and targeting federal buyers, however Spec-Links™ can be applied to any institution. For instance, Spec-Links™ could be applied to organizational and governmental awards and standards on safety or quality, and the system would then target concerned parents and consumers interested in buying the safest and highest quality products on the market.

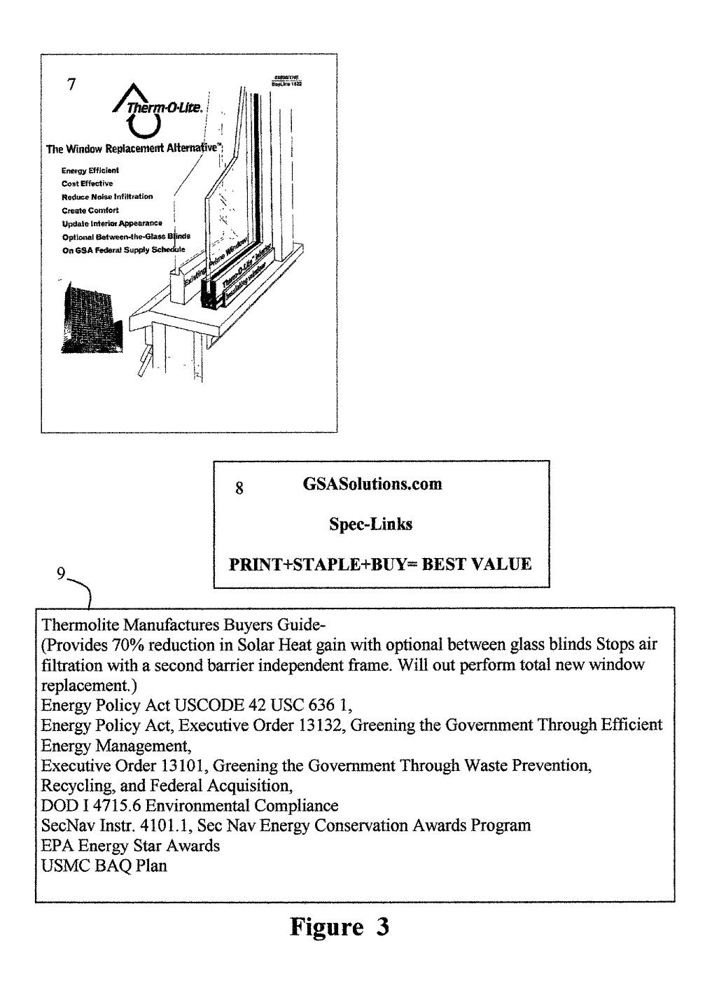

The three main windows of FIG. 3 are product window 7, host window 8, and Spec-Link window 9. Product window 7 has information about a product that is for sale and has been determined to qualify for inclusion in the present system. The product information can be in the form of text, pictures, slogans, logos, graphs, symbols or any combination thereof or a multi-media presentation. Product window 7 gives the purchaser a chance to recognize the product by sight and confirm that that is the product he was looking for. In FIG. 3, the product is an energy efficient double pained glass window for high rise buildings. A cut away diagram of the product is shown and important features of the product are listed. Host window 8 lists the host of the website, the name Spec-Links™, and the reason why the product can be purchased by a restricted purchaser, such as a government buyer. In this case the window qualifies as a “best value” for federal procurement purposes. This “best value” display lets the buyer know up front that the shown product can be purchased by a federal buying agent. Justification window 9 lists all of the rules, regulations, orders, and statutes (“regulations”) that the product meets. Each regulation is presented as a hyperlink, or Spec-Link™, that can be clicked on with a pointing device and will take the buyer to the associated regulation, which can be printed locally and will provide affirmative evidence of justification. The text of the regulations can be stored in the same secure server that houses the goods and services database or the link can lead to a government or organization hosted webpage. The regulations and awards are presented to the buyers in order of precedence so that the regulations that are most likely to control the buyers actions are listed first. A sample guide that may be used to decide ordering of regulations follows.

Manufactures Buyers Guide, which includes: warranty; unique manufacturing processes; environmental compliance; and one of a kind design features.

US Policy Codes

Executive Orders

Federal Acquisition Regulations (FAR)

Federal Agency Regulations

Department of Defense Instructions

Armed Services Instructions and Orders

Division Orders

Brigade Instructions

Battalion Orders

Company Orders

Directives such as award programs for energy compliance

Federal Agency Checklists for best value guidelines

All linked documents are presented to the buyer in a printable format. In order to make a purchase that will be fully justified, the buyer simply; prints the Spec-Links™, staples it to the purchase-ordering document and buys the product. This system provides a simple Print, Staple and Buy process for what used to be a very complicated and time consuming procedure. And the purchasing agent is now able to validate their procurement decision to the American taxpayers by showing proof of compliance in obtaining the “best value” purchase.

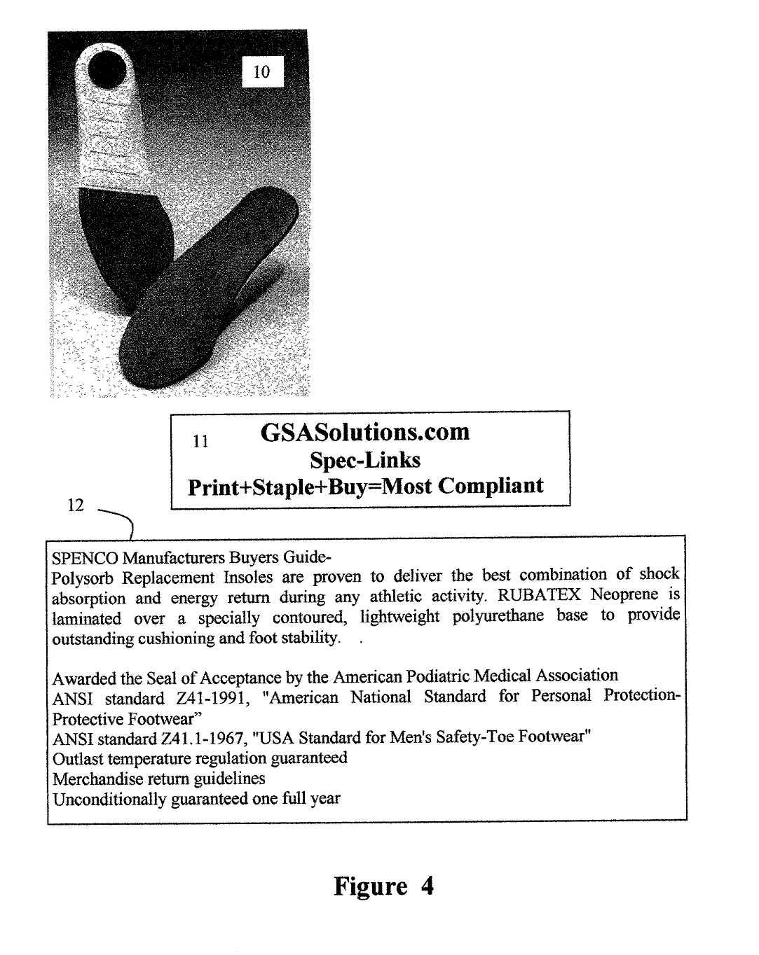

FIG. 4 shows an exemplary Spec-Links™ webpage for the present electronic commerce system. In the webpage of FIG. 4, product window 10 displays a high resolution picture of a pair of Spenco® shock absorption insoles. Such high resolution pictures will provide immediate recognition, if the purchaser knows the product for which she is looking. In other embodiments, the product window can play a video clip of the product, when appropriate. Of course the video clip could be multi-media and include sound and text. Host window 11 displays the website host and Spec-Links™ is displayed to promote recognition and to remind the restricted buyer and the concerned consumer that the system they are using is specifically designed to meet all of their needs. It is worth mentioning again that the federal government has been used only as a model institution in disclosing the present invention. The present electronic commerce system can be adapted to find products and services that fall within the “regulations” of any institution, such as State and local governments, corporations and organizations. Further, the present system can be adapted to meet specific regulations within an institution, such as “best value”, “most compliant”, “energy star award”, and minority owned, each of which are programs with specific regulations, that are sponsored by the federal government.

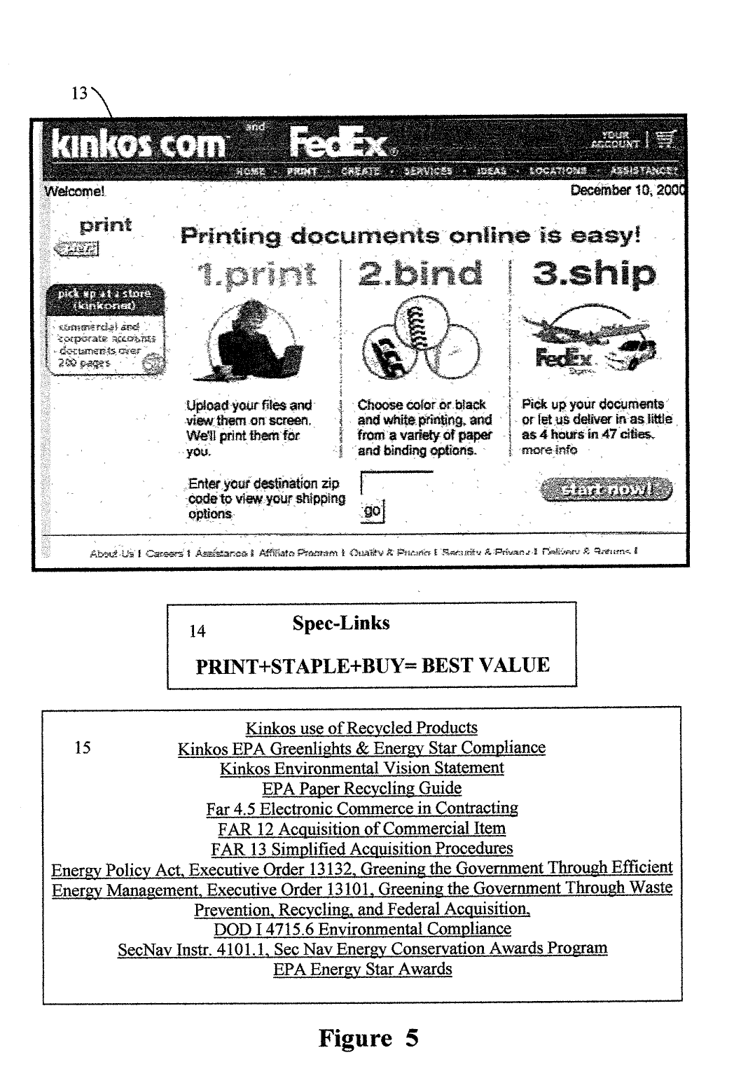

FIG. 5 shows an exemplary webpage of an alliance of companies that have implemented Spec-Links™ in their website. Product window 13 provides a multimedia presentation of the services offered by the companies, in this case Kinkos.com and FedEx®. In FIG. 5, product window 13 also provides data base searching capabilities as well as links to other company webpages. Host window 14 does not show GSASolutions.com because the website is hosted by the above alliance of companies. In this case the hosts names are shown elsewhere, as mentioned above the host window is optional and can be used to show any information. Spec-Links™ is shown in window 14 to assure the institutional buyer that he is getting quality information that is specifically designed to meet his needs. The specific program for which the product qualifies, “best value” in this case, is also displayed in window 14. Justification window 15 lists applicable regulations which the services meet, in order of precedence as applicable to the institutional buyer.

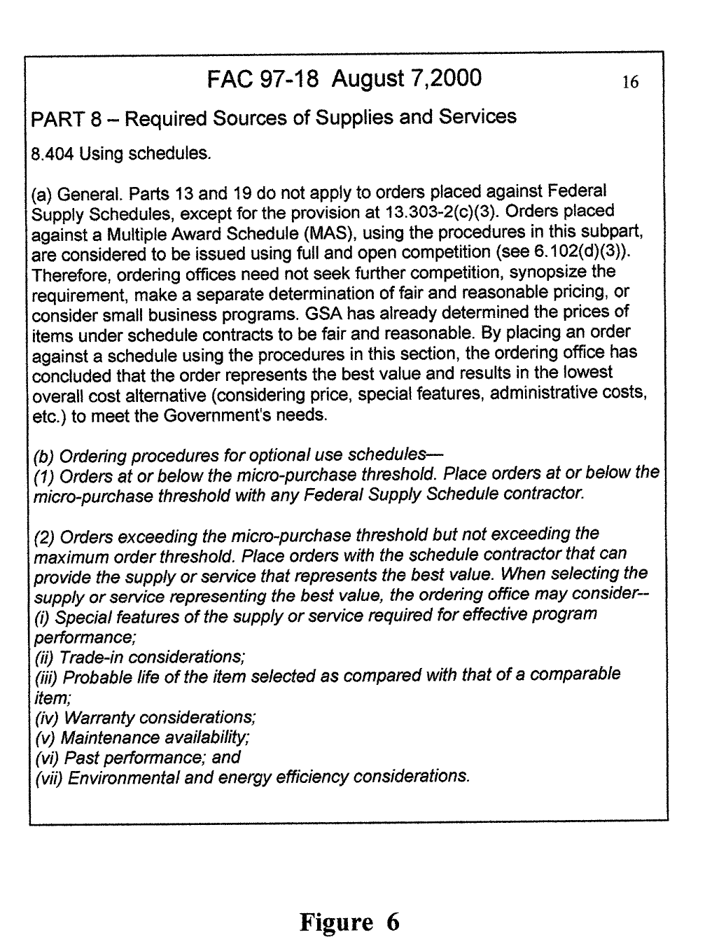

FIG. 6 is an exemplary webpage that the buyer is taken to when he clicks on one of the “regulations” or “awards” hyper links listed in a Spec-Links window. In this case the buyer clicked on a “Federal Acquisition Regulations” Spec-Link and was taken to the pertinent section of the FAR. The text within the regulation of specific concern to the buyer can optionally be highlighted or italicized as has been done in portions of the text of FIG. 6. This link to FAR section 8, as are all links to “regulations” and “awards”, can be printed locally by the buyer and may be used as justification for a purchase.

Of course other broad and specific webpages, relating to goods and services that meet the needs of the buyers, can supplement those shown. The entire product information database is housed in at least one secure server and provides logical hierarchical search capabilities that easily guide the buyer to a desired product. Security can also be provided for all hyper links, both within and outside the hosted website, through the well known framing security system. As mentioned above, the present Spec-Link™ idea could be used to provide information to buyers that are not restricted. For instance, if a homeowner needed to replace a door in his home he might need information provided in the house's architectural specifications. A system could easily be employed that provided hyper links to various architectural specifications. In this case the buyer would be an unrestricted buyer that would benefit from Spec-Links™. Further, the present invention could provide hyper links to government approved, or otherwise award winning, products and services wherein the system targets unrestricted buyers, such as soccer moms, that have an interest in safe, government approved goods and services.

In the above disclosure, government buyer, institutional buyer, limited buyer and restricted buyer each have used and all are intended to refer to the same basic person, a purchasing agent who must adhere to some “regulations” in the conduct of his business. In other words, a person that in some way must justify his purchases. The present electronic commerce system provides a realization of some of the promises made many years ago during the birth of the digital age. The heavy burden of legal and specification research to justify purchases has been lifted off the shoulders of institutional buyers. Further, the present electronic commerce system promotes environmental awareness, fair competition and compliance with safety standards. The reward of gaining access to a new customer pool is withheld to only those companies that meet energy efficiency and safety standards. Companies that offer lower priced and lower quality products that do not meet efficiency or safety standards will be force to compete fairly with companies that do meet those standards before they will be promoted to buyers.

The foregoing description of the specific embodiments will so fully reveal the general nature of the invention that others can, by applying current knowledge, readily modify and/or adapt for various applications such specific embodiments without departing from the generic concept. Therefore, such adaptations and modifications should and are intended to be comprehended within the meaning and range of equivalents of the disclosed embodiments. It is to be understood that the phraseology of terminology employed herein is for the purpose of description and not of limitation.

I claim:

1. An electronic commerce system executed on networked computer hardware and designed to provide a buyer with information regarding goods and services that meet regulations to which the buyer must adhere and goods and services that have won awards in which the buyer is interested, wherein, the information provides the buyer with justification of the purchase or assurance of safety and/or quality of the goods and services, comprising:
a product information module that displays descriptive information regarding products, wherein the descriptive information has been obtained from a product's manufacturer or distributor, and further wherein
the descriptive information is displayed in the form of text, a picture, a video clip or a multi-media presentation;
a justification module that displays justification information regarding the products, wherein the justification information includes hyper links to specific regulations to which the buyer must adhere and to specific awards which the product has won, and wherein the regulations and awards are listed in order of precedence, and further wherein,
the linked specific regulations and awards provide printable evidence of a purchase being justified and of the safety and quality of the good or service; and
a host module that optionally displays a host name, any institutionally sponsored programs for which the product qualifies and other miscellaneous information.

2. The electronic commerce system of claim 1 wherein, the networked computer hardware comprises lap-top computers, desk-top computers, servers, routers, personal digital assistants, and cellular telephones, and wherein the hardware is connected via the Internet, a LAN and/or a WAN.

3. The electronic commerce system of claim 1 wherein, the justification information further provides specification information that is required before the purchase can be made.

4. The electronic commerce system of claim 1 wherein, webpages are accessed via a website and the website is hosted by a government, a company or an alliance of companies.

5. The electronic commerce system of claim 1 wherein, the system specifically target goods and services that meet specific regulations within an institution, such as the “best value” program of the federal government.

6. The electronic commerce system of claim 1 wherein, the buyer is able to print out all required justification information, staple the printed information to a purchase order and subsequently have everything required to buy the good or service.

7. The electronic commerce system of claim 1 wherein, the product information module provides searching capabilities, links to other webpages and electronic shopping carts.

8. A method of providing information to buyers over networked computer hardware so that a restricted buyer, such as a purchasing agent, can justify purchases and an unrestricted buyer, such as a concerned parent, can receive some reassurance of safety or quality and then make a more informed purchase, comprising the steps of:
gathering information on goods and services that meet specified regulations and have won specified awards;
storing the information in a searchable database, the database comprising a product information module that stores product description information and a justification module that stores regulations and awards information;
displaying the information on a website wherein a product or service is shown as a picture, text, a video clip or a multi-media display and further wherein each product and service has an associated Spec-Link icon; and
clicking on the Spec-Link icon to gain access to rules, regulations, statutes and Orders (“regulations”) that the good or service meets and to honors, accolades and awards (“awards”) won by the good or service;
printing a copy of any pertinent regulation or award and using the printed document as justification of the purchase or evidence of safety or quality.

9. The method of claim 8 wherein, the networked computer hardware comprises lap-top computers, desk-top computers, servers, routers, personal digital assistants, and cellular telephones, and wherein the hardware is connected via the Internet, a LAN and/or a WAN.

10. The method of claim 8 wherein, the justification information further provides specification information that is required before the purchase can be made.

11. The method of claim 8 wherein, webpages are accessed via a website and the website is hosted by a government, a company or an alliance of companies.

12. The method of claim 8 wherein, the system specifically target goods and services that meet specific regulations within an institution, such as the “best value” program of the federal government.

13. The method of claim 8 wherein, the regulations and awards are listed in order of precedence and the buyer is able to print out all required justification information, staple the printed information to a purchase order and subsequently have everything required to buy the good or service.

14. The method of claim 8 wherein, the product information module provides searching capabilities, links to other webpages and electronic shopping carts.
